(19) United States
(12) Patent Application Publication
(10) Pub. No.: US 2026/0174631 A1
(43) Pub. Date: Jun. 25, 2026

(54) HOT AND COLD TUB ASSEMBLIES WITH PELTIER TEMPERATURE CONTROLSYSTEMS

(71) Applicant: Bi-Polar Holding Company LLC, Salt Lake City, UT (US)

(72) Inventor: Jeffrey Turner, Salt Lake City, UT (US)

(73) Assignee: Bi-Polar Holding Company LLC, Salt Lake City, UT (US)

(21) Appl. No.: 19/270,153

(22) Filed: Jul. 15, 2025

Related U.S. Application Data
(60) Provisional application No. 63/671,690, filed on Jul. 15, 2024.

(51) Int. Cl. A61H 33/00; A61H 33/02

(52) U.S. Cl. CPC A61H 33/0095; A61H 33/0087; A61H 33/02; A61H 33/601; A61H 33/6068; A61H 2201/0207; A61H 2201/0214; A61H 2201/0285

(57) ABSTRACT

Hot tub and cold tub systems and temperature regulation systems that may be used with hot/cold tub systems. The temperature regulation systems in a series of manifold blocks or “engines”, each including a first manifold that allows a seal to be made against a first surface of one or more Peltier chips and defines a flow path for a fluid to directly contact the first surfaces of the Peltier chip(s) while flowing through the first manifold, and a second opposite manifold that defines a flow path for a heat transfer fluid which directly contacts the second surfaces of the Peltier chip(s). The system is configured so that fluid circulates fluid from a first tub through the first side of at least one manifold block and from there to and through the first sides of any additional manifold blocks in the series, contacting the first sides of the Peltier chip(s) therein.

### CROSS-REFERENCE TO RELATED APPLICATION

This application claims the benefit of U.S. Provisional Application No. 63/671,690, filed Jul. 15, 2024, the disclosure of which is incorporated herein by reference in its entirety.

### TECHNICAL FIELD

The present invention relates generally to hot tub and cold tub systems and apparatus for controlling the operating temperature such systems.

### BACKGROUND

Hydrotherapy using alternate hot and cold plunges has long been used. Typically, separate pools or tubs have been used to provide the different temperature bodies of water, each with a separate temperature control system. A system that could simultaneously heat water for a hot tub and cool water for a cold tub using a common temperature control elements would be an improvement in the art. Such a system that supports energy efficient hot tub and cold tub units would be a further improvement in the art.

### SUMMARY

The present invention provides systems and apparatus for heating and cooling water for use in hot tubs and cold tubs. In some embodiments, a temperature regulation system may include a series of manifolds blocks or “engines”, each manifold block includes a first manifold that allows a seal to be made against a first surface of one or more Peltier chips and defines a flow path for a fluid to directly contact the first surfaces of the Peltier chip(s) while flowing through the first manifold, and a second opposite manifold that defines a flow path for a heat transfer fluid which directly contacts the second surfaces of the Peltier chip(s). The system is configured so that fluid circulates from a first tub through tubing to the first side of at least one manifold block and from there to, and through. the first sides of any additional manifold blocks in the series, contacting the first sides of the Peltier chip(s) therein, then returning to the first tub. A second loop of heat transfer fluid circulates through tubing through the second manifold of the first manifold block, contacting the second surfaces of the Peltier chip(s) therein, to a corresponding first radiator. One or more fans may be placed to encourage airflow through the first radiator. The fluid then flows from the first radiator to the second manifold of the subsequent manifold blocks, contacting the second surfaces of the Peltier chip(s) therein, and their corresponding radiators, returning to the first manifold block. Application of current in a first direction to the Peltier chip(s) can heat the fluid in the tub and reversal of the current may be used to cool the tub with heat dissipated though the radiators.

In another illustrative embodiment, a temperature regulation system may include a series of manifolds blocks or “engines”, each manifold block includes a first manifold that allows a seal to be made against a first surface of one or more Peltier chips and defines a flow path for a fluid to directly contact the first surfaces of the Peltier chip(s) while flowing through the first manifold, and a second opposite manifold that defines a flow path for a heat transfer fluid which directly contacts the second surfaces of the Peltier chip(s). The system is configured so that fluid circulates from a first tub through tubing to the first side of at least one manifold block and from there to, and through, the first sides of any additional manifold blocks in the series, contacting the first sides of the Peltier chip(s) therein, then returning to the first tub. A second loop of fluid circulates from a second tub through tubing through the second manifold of the first manifold block, contacting the second surfaces of the Peltier chip(s) therein, from there to and through the second sides of any additional manifold blocks in the series, contacting the second sides of the Peltier chip(s) therein, then returning to the second tub. Application of current in a first direction to the Peltier chip(s) can heat the fluid in the first tub and cool the fluid in the second tub.

In a third type of illustrative embodiments, a temperature regulation system may include a series of manifolds blocks or “engines”, each manifold block includes a first manifold that allows a seal to be made against a first surface of one or more Peltier chips and defines a flow path for a fluid to directly contact the first surfaces of the Peltier chip(s) while flowing through the first manifold, and a second opposite manifold that defines a flow path for a heat transfer fluid which directly contacts the second surfaces of the Peltier chip(s). The system is configured so that fluid circulates from a first tub through tubing to the first side of at least one manifold block and from there to, and through, the first sides of any additional manifold blocks in the series, contacting the first sides of the Peltier chip(s) therein, then returning to the first tub. A second loop circulates fluid from a second tub through tubing to and through the second manifold of the first manifold block, contacting the second surfaces of the Peltier chip(s) therein, to a corresponding first radiator. One or more fans may be placed to encourage airflow through the first radiator. The fluid then flows from the first radiator to the second manifold of the subsequent manifold blocks, contacting the second surfaces of the Peltier chip(s) therein, and their corresponding radiators, returning to the second tub. Application of current in a first direction to the Peltier chip(s) can heat the fluid in the first tub and cool the fluid in the second tub.

In a fourth illustrative embodiment, a temperature regulation system may include a first series of manifolds blocks or “engines”, each manifold block of the first series includes a first manifold that allows a seal to be made against a first surface of one or more Peltier chips and defines a flow path for a fluid to directly contact the first surfaces of the Peltier chip(s) while flowing through the first manifold, and a second opposite manifold that defines a flow path for a heat transfer fluid which directly contacts the second surfaces of the Peltier chip(s). The system is configured so that fluid circulates from a first tub through tubing to the first side of at least one manifold block and from there to, and through, the first sides of any at least one more additional manifold blocks in the first series, contacting the first sides of the Peltier chip(s) therein, then returning to the first tub. A second loop of fluid circulates from a second tub through tubing through the second manifold of one of the subsequent manifold blocks of the first series, contacting the second surfaces of the Peltier chip(s) therein, from there to and through the second sides of any additional subsequent manifold blocks in the series, contacting the second sides of the Peltier chip(s) therein and then returning to the second tub.

A third loop of fluid, which may be a heat transfer fluid, circulates through tubing through the second manifold of a first manifold block of the second series of manifold blocks, contacting the first surfaces of the Peltier chip(s) therein, to a corresponding first radiator. One or more fans may be placed to encourage airflow through the first radiator. The fluid may then flow from the first radiator to the first manifold of a subsequent manifold block, contacting the first surfaces of the Peltier chip(s) therein, and its corresponding radiator(s), returning to the first manifold block.

The various illustrative systems may include appropriate bypass valving to allow for temperature adjustment and maintenance. Systems used for recreational or therapeutic hot tubs and/or cold tubs may also include air pumps for aeration of the tub(s).

### DESCRIPTION OF THE DRAWINGS

It will be appreciated by those of ordinary skill in the art that the various drawings are for illustrative purposes only. The nature of the present disclosure, as well as other varying embodiments, may be more clearly understood by reference to the following detailed description, and to the drawings, as well as to the appended claims.

FIGS. 1A, 1B, 1C and 1D are diagrammatic views of illustrative hot tub/cold tub systems utilizing temperature control system systems in accordance with the present disclosure.

FIG. 2A is a bottom view of a manifold useful in the system of FIGS. 1A through 1D.

FIG. 2B is a side view of a manifold block including the manifold of FIG. 2A, in containing a Peltier element and in fluid communication with a radiator assembly.

FIG. 3 is a diagram of an illustrative embodiment of a hot and cold tub assembly including a first illustrative temperature control system in accordance with the principles of the present disclosure.

FIG. 4 is a diagram of an illustrative embodiment of a hot and cold tub assembly including a second illustrative temperature control system in accordance with the principles of the present disclosure.

FIG. 5 is a diagram of an illustrative embodiment of a hot and cold tub assembly including a third illustrative temperature control system in accordance with the principles of the present disclosure including air injection pumps.

FIGS. 6A and 6B are diagrams of additional illustrative embodiments of a hot and cold tub assemblies including temperature control systems with bypass valves arrangements useful in systems in accordance with the principles of the present disclosure.

FIG. 7 is a diagram of another illustrative embodiment of a hot and cold tub assembly including another temperature control system in accordance with the principles of the present disclosure.

### DETAILED DESCRIPTION

The present disclosure relates to systems, methods and apparatus for controlling the temperature of a therapeutic or recreational hot tub or cold tub. It will be appreciated by those skilled in the art that the embodiments herein described, while illustrating certain embodiments, are not intended to limit the disclosure. Those skilled in the art will also understand that various combinations or modifications of the embodiments presented herein can be made without departing from the scope of this disclosure and that all such alternate embodiments are within the scope of this description. Similarly, while the drawings depict illustrative embodiments of the devices and components illustrate the principles upon which those devices and components are based, they are only illustrative, and any modifications of the features presented here are to be considered within the scope of this disclosure. The attached appendix includes flow diagrams for some additional illustrative embodiments in accordance with the present disclosure.

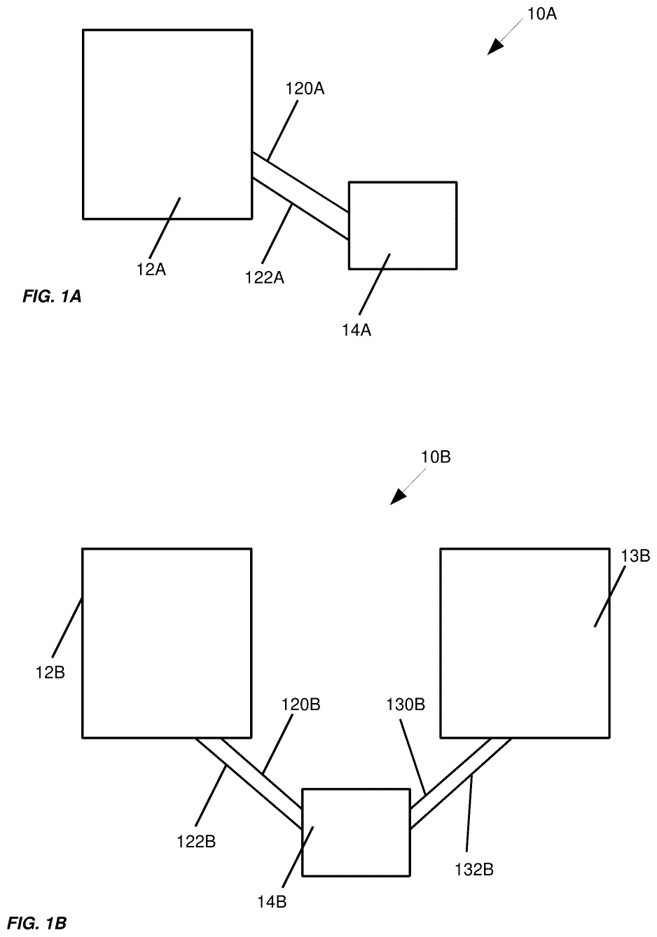

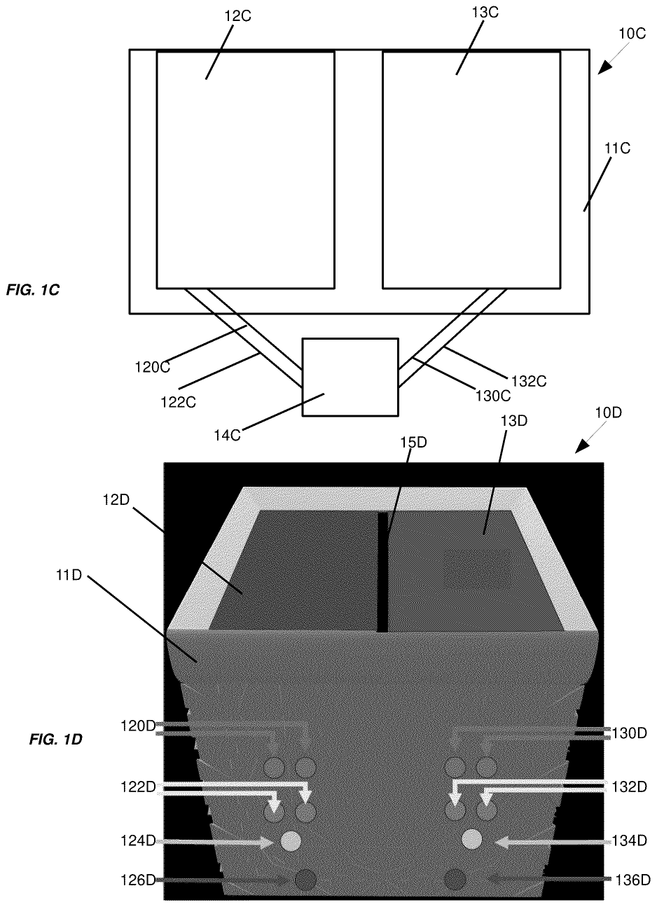

FIGS. 1A, 1B, 1C and 1D are diagrammatic views of illustrative hot tub/cold tub systems 10A, 10B, 10C and 10D with the temperature control systems of the present disclosure. System 10A includes a single tub assembly 12A formed as a tub for containing water and a temperature control system, generally indicated at 14A which is in fluid communication with the tub assembly 12A through tubing 120A and 122A.

Systems 10B and 10C each include a first tub assembly, 12B or 12C, formed as a tub for containing water, a second tub assembly, 13B or 13C, formed as a tub for containing water and a temperature control system, generally indicated at 14B or 14C which is in fluid communication with the tub assemblies 12B or 12C through tubing 120B, 120C and 122B, 122C, and in fluid communication with the tub assemblies 13B or 13C through tubing 130B, 130C and 132B, 132C. As depicted in system 10B, the two tubs 12B and 13B may be separate assemblies that are spaced apart from one another. Alternatively, as depicted in system 10C, the two tubs 12C and 13C may be contained in common body 11C.

FIG. 1D depicts a common body 11D that houses the two separate tub assemblies 12D and 13D, separated by a thermally insulative wall 15D. The wall of body 11D near the first tub includes a number of ports, including ports 120D and 122D to allow access to the first tub 12D for connection to tubing for fluid flow, port 124D to allow air to enter into an aeration system in the first tub 12D and a drain 126D to allow the first tub 12D to be emptied. Similarly, the wall of body 11D near the second tub includes a number of ports, including ports 130D and 132D to allow access to the second tub 13D for connection to tubing for fluid flow, port 134D to allow air to enter into an aeration system in the second tub 13D and a drain 136D to allow the second tub 13D to be emptied.

It will be appreciated that the tubs and bodies of the various embodiments may be formed of any suitable materials, including polymeric materials and of suitable size for use as therapeutic or recreational spas. In some embodiments, the temperature control system may be disposed in a separate housing that is connected to the tubs by suitable tubing. In other embodiments, it may be housed in a portion of the same body. In certain embodiments, a tub or a body containing one, two, or more tubs may be constructed as a collapsible or inflatable body allowing it to be set up at a desired location then taken down for storage or transport. Other embodiments may be constructed from solid materials for long term installations.

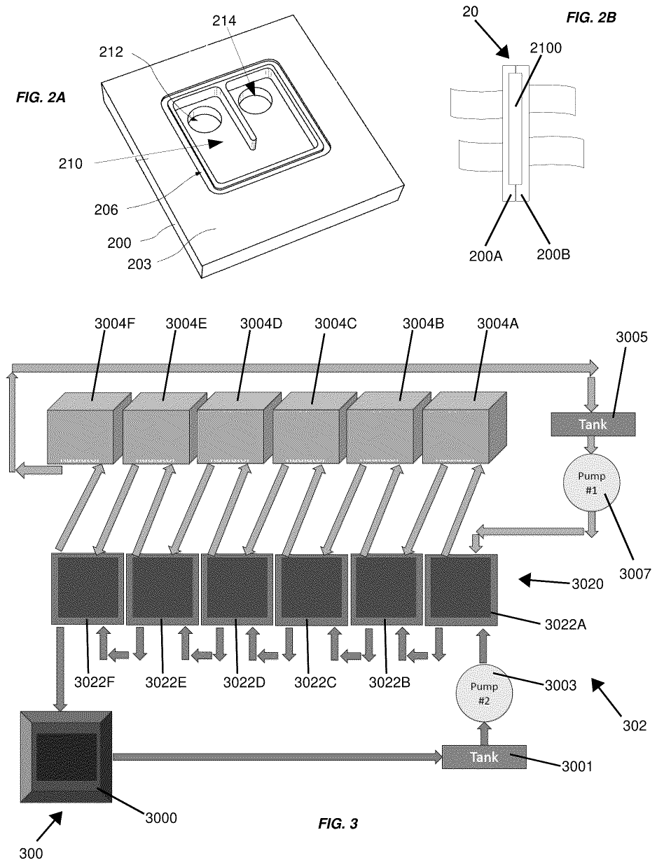

Turning to FIGS. 2A and 2B, one illustrative embodiment of a manifold 200 and a manifold block 20 for use with a Peltier chip 2100 in temperature control systems in accordance with the present disclosure is depicted. Peltier chip 2100 is a thermoelectric converter element whose effect is based on the Peltier principle in that it is capable of both cooling and heating by virtue of the fact that between their electrodes a temperature differential is created whose directionality is a function of the direction of the current. A typical Peltier chip 2100 currently in use may be operated at from about 11 to about 15 volts to achieve optimal performance. It will be appreciated that different voltages may be used as the particular chips 2100 may vary.

As depicted in FIG. 2B, the two opposite sides of the Peltier chip 2100 are each secured in a manifold block 20, with the two manifolds 200A and 200B facing one another to form a manifold block 20 block with the Peltier chip secured therein. This allows a seal to be made against each opposite surface of the Peltier chip 2100 to define a flow path for a heat transfer fluid which directly contacts the surface of the Peltier chip 1100 as the fluid flows through the respective manifold 200.

Some additional details of manifold 200 are depicted in FIG. 2A, where the face 203 of manifold 200 is best depicted. Face 203 contains at least one recess for receiving a Peltier chip 2100, the recess contains a flow path 210, which may be formed as a channel having a Z, S or other shape to direct the flow of a heat transfer liquid from one opening 212 to another 214. A recessed notch 206 is present to hold a seal, such as an O-ring, and may provide a seat for a chip 2100.

In use, the seal may be an O-ring that is significantly thicker in height than the recessed depth of notch 206. This allows the O-ring to function both as a sealing element and as an adjustment element to account for any variations that may occur between various chips 2100 due to manufacturing differences. It also allows the O-ring to function as a cushion, protecting the chip 2100 from forces that may otherwise damage it during assembly of the system or during operation.

Manifold 200 may further include a plurality of connection members to secure the chip 2100 in place. Any suitable connection members or connection system, including adhesive number may be used, provided a suitable seal can be achieved. Manifold 200 may be constructed from an injected molded plastic material capable of absorbing the thermal changes associated with the temperature control system in which it is used.

Manifold block 20 may be formed from two manifolds, designated first manifold 200A and second manifold 200B, which may be joined face to face with at least one Peltier chip 2100 sandwiched therebetween. Suitable examples of manifold blocks are described in U.S. Pat. No. 10,405,650, which issued Sep. 10, 2019, the contents of which are incorporated herein in their entirety. The first and second sides of Peltier chip 2100 are respectively secured in secured in manifolds 200A and 200B which allow a seal to be made against the respective surfaces of the Peltier chip 2100 to define flow paths for fluids which directly contact the Peltier chip surfaces on either side though the associated tubing. It will be appreciated that although a manifold 200 having a single seat for a single Peltier chip 2100 is depicted, that embodiments having multiple seats for multiple Peltier chips to be seated therein with a flow channel that allows for fluid contact against the surfaces of the multiple chips may be used.

Turning to FIG. 3, a diagram of a first illustrative embodiment of a hot and cold tub assembly 300 including a tub 3000 and a temperature control system 302 is depicted, in accordance with the principles of the present disclosure is depicted. Temperature regulation system 302 includes a series 3020 of manifolds blocks or “engines”, each manifold block (3022A through 3022F) includes a first manifold as discussed previously herein that allows a seal to be made against a first surface of one or more Peltier chips (such as the indicated four Peltier chips in each “Quad Engine”) and defines a flow path for a first fluid to directly contact the first surfaces of the Peltier chip(s) while flowing through the first manifold, and a second opposite manifold that defines a flow path for a second heat transfer fluid which directly contacts the second surfaces of the Peltier chip(s). As depicted, in system 300, the first fluid is water for use in Hot/Cold Tub 3000 which circulates from the tub 3000 through tubing to the first side of at least one manifold block 3022A and from there to and through the first sides of any additional manifold blocks 3022B, 3022C, et seq. in the series, contacting the first sides of the Peltier chip(s) therein, then returning to the first tub 3000. A second loop of heat transfer fluid circulates through tubing through the second manifold of the first manifold block 3022A, contacting the second surfaces of the Peltier chip(s) therein, to a corresponding first radiator assembly 3004A, which may include one or more radiators and one or more fans placed to encourage airflow through the radiator(s). The fluid then flows from the first radiator assembly 3004A to the second manifold of the subsequent manifold block 3002B, contacting the second surfaces of the Peltier chip(s) therein, and its corresponding radiator assembly 3004B, continuing to flow through any subsequent second manifolds of the series 3020 and their associated radiator assemblies before returning to the first manifold block 3022A. Application of current in a first direction to the Peltier chip(s) can heat the fluid in the tub and reversal of the current may be used to cool the tub with heat dissipated though the radiators.

As depicted suitable pumps 3003 and 3007 are in operative connection with the respective loops to provide fluid flow and suitable tanks 3001 and 3005 may be present to provide fluid reservoirs. The pumps may be any pump with sufficient power to circulate the fluids through the tubing at a rate sufficient to allow the system to function at an acceptable rate of heating or cooling. Typically, centrifugal-type pumps may be used, although it may be possible to utilize a larger in-line pump. Some potential heat transfer fluids for use on the second loop include water and other acceptable commercially available coolants, such as PAHNOL, offered by Houton Chemical.

The tubing used to connect the tub 3000 to the temperature control system 302 tubing may be connected to suitable ports in the tub 3000. Each radiator assembly 3004A, et seq, may include one or more standard radiators consisting of tubing that passes through fins to provide a larger surface area for convection heat exchange to the surrounding air. One or more fans may be associated with the radiators to create a desired airflow upon activation.

It will be appreciated that while the depicted system 302 includes six manifold block “engines” and their corresponding radiator assemblies, that embodiments having varying numbers of manifolds are contemplated to allow for scaling to varying size tubs, different efficiency Peltier elements for different applications.

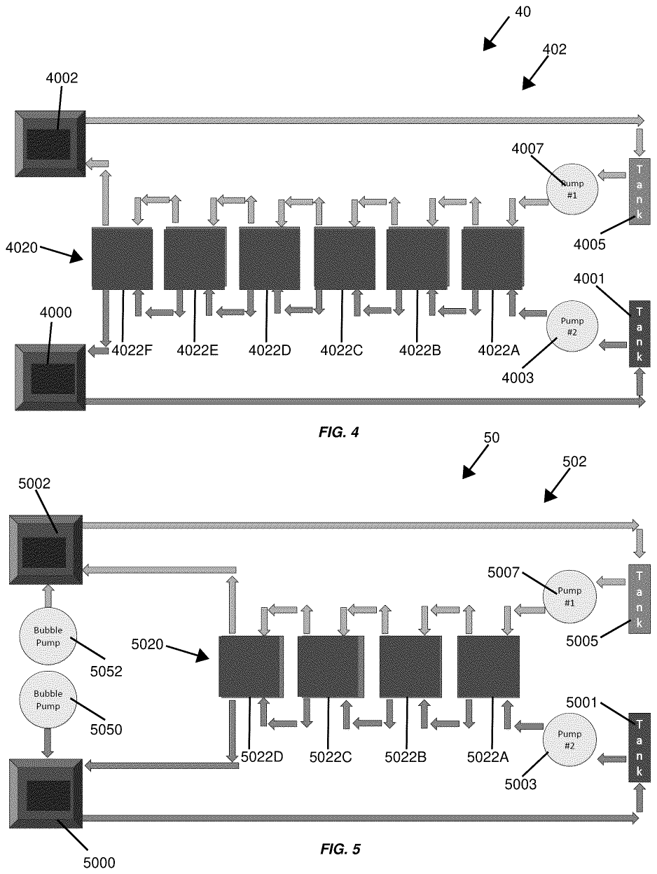

Turning to FIG. 4, a diagram of an illustrative embodiment of a system 40, including a first tub 4000 a second tub 4002 and a temperature control system 402 is depicted, in accordance with the principles of the present disclosure. As depicted, temperature regulation system 402 includes a series 4020 of manifolds blocks or “engines”, each manifold block (4022A, 4022B, et seq.) thereof includes a first manifold as discussed previously herein that allows a seal to be made against a first surface of one or more Peltier chips (such as the indicated four Peltier chips in each a “Quad Engine”) and defines a flow path for a first fluid to directly contact the first surfaces of the Peltier chip(s) while flowing through the first manifold, and a second opposite manifold that defines a flow path for a second fluid which directly contacts the second surfaces of the Peltier chip(s).

As depicted, system 402 is configured so that fluid circulates from first tub 4000 through tubing to the first side of least one manifold block 4022A and from there to and through the first sides of any additional manifold blocks in the series (4022B, 4022C, 4022D. 4022E and 4022F), contacting the first sides of the Peltier chip(s) therein, then returning to the first tub. A second loop of fluid circulates from second tub 4002 through tubing through the second manifold of the first manifold block 4022A, contacting the second surfaces of the Peltier chip(s) therein, from there to and through the second sides of any additional manifold blocks in the series, contacting the second sides of the Peltier chip(s) therein, then returning to the second tub. Application of current in a first direction to the Peltier chip(s) can cool the fluid in the first tub 4000 and heat the fluid in the second tub 4002.

As depicted, suitable pumps 4003 and 4007 are in operative connection with the respective loops to provide fluid flow and suitable tanks 4001 and 4005 may be present to provide fluid reservoirs. The pumps may be any pump with sufficient power to circulate the fluids through the tubing at a rate sufficient to allow the system to function at an acceptable rate of heating or cooling. Typically, centrifugal-type pumps may be used, although it may be possible to utilize a larger in-line pump. The tubing used to connect the tubs 4000 and 4002 to the temperature control system 402 may be connected to suitable ports in the tub 4000 using suitable fasteners.

It will be appreciated that while the depicted system 402 includes six manifold block “engines”, that embodiments having varying numbers of manifolds are contemplated to allow for scaling to varying size tubs, different efficiency Peltier elements for different applications.

FIG. 5 is a diagram of an illustrative embodiment of a system 50, including a first tub 5000 a second tub 5002 and a temperature control system 502 which is similar to the system of FIG. 4, with the addition of air pump 5050 which is connected via tubing to supply air to aeration ports in first tub 5000, and air pump 5052 which is connected via tubing to supply air to aeration ports in second tub 5002.

Temperature control system 502 includes a series 5020 of manifolds blocks or “engines”, each manifold block (5022A, 5022B, et seq.) thereof includes a first manifold as discussed previously herein that allows a seal to be made against a first surface of one or more Peltier chips (such as the indicated four Peltier chips in each a “Quad Engine”) and defines a flow path for a first fluid to directly contact the first surfaces of the Peltier chip(s) while flowing through the first manifold, and a second opposite manifold that defines a flow path for a second fluid which directly contacts the second surfaces of the Peltier chip(s).

As depicted, system 502 is configured so that fluid circulates from first tub 5000 through tubing to the first side of least one manifold block 5022A and from there to and through the first sides of any additional manifold blocks in the series (5022B, 5022C, and 5022D), contacting the first sides of the Peltier chip(s) therein, then returning to the first tub. A second loop of fluid circulates from second tub 5002 through tubing through the second manifold of the first manifold block 5022A, contacting the second surfaces of the Peltier chip(s) therein, from there to and through the second sides of any additional manifold blocks in the series, contacting the second sides of the Peltier chip(s) therein, then returning to the second tub. Application of current in a first direction to the Peltier chip(s) can cool the fluid in first tub 5000 and heat the fluid in the second tub 5002.

As depicted, suitable pumps 5003 and 5007 are in operative connection with the respective loops to provide fluid flow and suitable tanks 5001 and 5005 may be present to provide fluid reservoirs. The pumps may be any pump with sufficient power to circulate the fluids through the tubing at a rate sufficient to allow the system to function at an acceptable rate of heating or cooling. Typically, centrifugal-type pumps may be used, although it may be possible to utilize a larger in-line pump. The tubing used to connect the tubs 5000 and 5002 to the temperature control system 502 may be connected to suitable ports in the tub 5000 using suitable fasteners.

It will be appreciated that while the depicted system 502 includes four manifold block “engines”, that embodiments having varying numbers of manifolds are contemplated to allow for scaling to varying size tubs, different efficiency Peltier elements for different applications.

Aeration pumps 5050 and 5052 allow for the selective introduction of air bubbles to the tubs 5000 and 5002. This can improve the user experience in the tubs and can allow for additional temperature adjustment as air at ambient temperature is injected into the tubs.

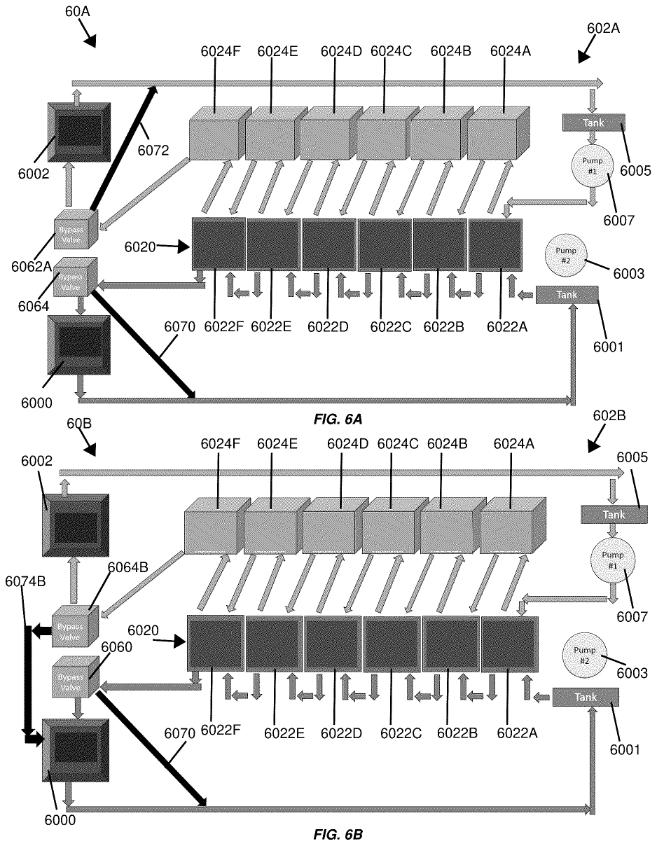

FIGS. 6A and 6B are diagrams of illustrative embodiments of a hot and cold tub assemblies 60A and 60B, each including first tub 6000, second tub 6002 and temperature control systems 602A and 602B. Like elements in the two systems are indicated with common reference numerals.

Each temperature regulation system 602A and 602B includes a series 6020 of manifolds blocks or “engines”, each manifold block (6022A, 6022B, et seq.) includes a first manifold as discussed previously herein that allows a seal to be made against a first surface of one or more Peltier chips (such as the indicated four Peltier chips in each a “Quad Engine”) and defines a flow path for a first fluid to directly contact the first surfaces of the Peltier chip(s) while flowing through the first manifold, and a second opposite manifold that defines a flow path for a second fluid which directly contacts the second surfaces of the Peltier chip(s). As depicted, the first fluid is water which circulates from first tub 6000 through tubing to the first side of at least one manifold block 6022A and from there to and through the first sides of any additional manifold blocks 6022B, 6022C, et seq. in the series, contacting the first sides of the Peltier chip(s) therein, then returning to the first tub 6000. A second loop of water circulates from second tub 6002 through tubing to the second manifold of the first manifold block 6022A, contacting the second surfaces of the Peltier chip(s) therein, to a corresponding first radiator assembly 6024A, which may include one or more radiators and one or more fans placed to encourage airflow through the radiator(s). The water then flows from the first radiator assembly 6024A to the second manifold of the subsequent manifold block 6022B, contacting the second surfaces of the Peltier chip(s) therein, and then its corresponding radiator assembly 6024B, continuing to flow through any subsequent second manifolds of the series 6020 and their associated radiator assemblies before returning to the second tub 6002. Application of current in a first direction to the Peltier chip(s) can cool the water in the first tub and heat the water in the second tub, with any excess heat dissipated though the radiators.

A first arrangement for bypass valves in the fluid loops is depicted in FIG. 6A, which includes bypass valve 6060 in the first loop and bypass valve 6062A in the second loop. Bypass valve 6064 is positioned between the final engine or manifold block 6022F and the first tub, selective activation of bypass valve 6064 allows the fluid flow returning from the final manifold block to be diverted from the first tub to return via alternate path 6070 to the series of manifold blocks in the first loop. Similarly, bypass valve 6062A is positioned between the final radiator assembly 6024F and the second tub, and selective activation of bypass valve 6062A allows the fluid flow returning from the second loop to be diverted from the second tub to return via alternate path 6072 to the series of manifold blocks in the second loop. Where a desired temperature is achieved for water in one tub (such as a hot temperature of about 104 degrees F or a cold temperature of about 39 degree F) but not the other tub, selective activation of the appropriate bypass valves 6060 or 6062A allows the system 602A to continue adjusting the temperature for the fluid in the other tub while the tub at the desired temperature is isolated.

A second arrangement for bypass valves in the fluid loops is depicted in FIG. 6B, which includes bypass valve 6060 in the first loop and bypass valve 6064B in the second loop. As Bypass valve 6060 is positioned between the final engine or manifold block 6022F and the first tub, selective activation of bypass valve 6060 allows the fluid flow returning from the final manifold block to be diverted from the first tub to return via alternate path 6070 to the series of manifold blocks in the first loop. In contrast, bypass valve 6064B is positioned between the final radiator assembly 6024F and the second tub, and selective activation of bypass valve 6064B allows the fluid flow returning from the second loop to be diverted from returning to the second tub to instead flow to the first tub 6000 and enter the first loop. Where the system is operated in conditions that heating the second tub to a desired temperature would cool the first tub below the desired temperature, or potentially cause freezing in the first loop, selective activation of the bypass valves 6064B can add heated water to the first tub and/or first loop to prevent freezing and/or help maintain the desired temperature. Although not depicted, it will be appreciated that a similar bypass arrangement may be present to divert flow from the first loop to the second loop for balancing fluid levels in the system.

As depicted suitable pumps 6003 and 6007 are in operative connection with the respective loops to provide fluid flow and suitable tanks 6001 and 6005 may be present to provide fluid reservoirs. The pumps may be any pump with sufficient power to circulate the fluids through the tubing at a rate sufficient to allow the system to function at an acceptable rate of heating or cooling. Typically, centrifugal-type pumps may be used, although it may be possible to utilize a larger in-line pump. The bypass valves may be any suitable valves for diverting all or a portion of the fluid flows. The bypass valves may be electronically actuated by the system.

The tubing used to connect the tubs 6000 and 6002 to the temperature control system 602A or 602B may be connected to suitable ports in the tubs. Each radiator assembly 6024A, et seq, may include one or more standard radiators consisting of tubing that passes through fins to provide a larger surface area for convection heat exchange to the surrounding air.

It will be appreciated that while the depicted systems 602A and 602B include six manifold block “engines” and their corresponding radiator assemblies, that embodiments having varying numbers of manifolds are contemplated to allow for scaling to varying size tubs, different efficiency Peltier elements for different applications.

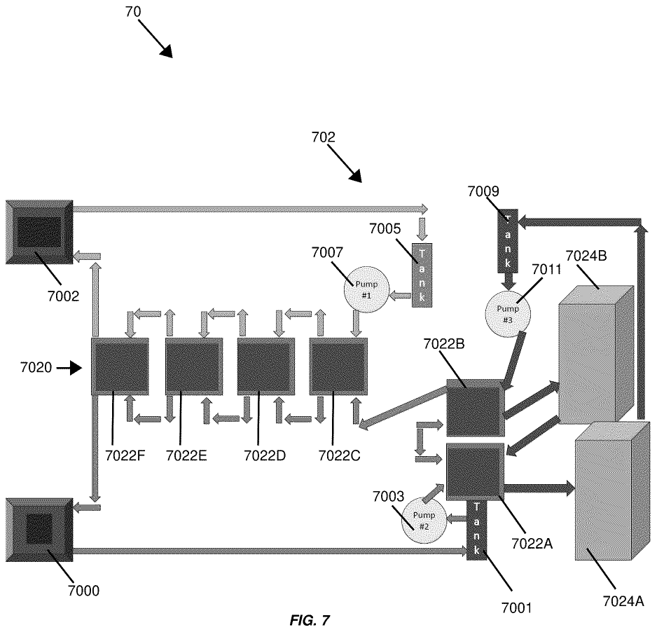

FIG. 7 depicts a diagram of an illustrative embodiment of a hot and cold tub assembly 70 including a first tub 7000, a second tub 7002, and a temperature control system 702 which includes three fluid flow loops.

As depicted, temperature regulation 702 system includes a series 7020 of manifolds blocks or “engines” (7022A, 7022B, et seq.). Each manifold block (7022A, 7022B, et seq.) includes a first manifold as discussed previously herein that allows a seal to be made against a first surface of one or more Peltier chips (such as the indicated four Peltier chips in each a “Quad Engine”) and defines a flow path for a first fluid to directly contact the first surfaces of the Peltier chip(s) while flowing through the first manifold, and a second opposite manifold that defines a flow path for a second fluid which directly contacts the second surfaces of the Peltier chip(s). The first fluid flow loop of system 702 is configured so that fluid circulates fluid from first tub 7000 through tubing to the first side of the first manifold block 7022A and from there to and through the first sides of all the manifold blocks in the first series (7022B, 7022C, 7022D. 7022E and 7022F in the depicted embodiment), contacting the first sides of the Peltier chip(s) therein, then returning to the first tub 7000. A second loop of fluid circulates from second tub 7002 through tubing through the second manifold of one of the subsequent manifold blocks of the series 7020, which in the depicted embodiment is the third manifold clock 7022C, contacting the second surfaces of the Peltier chip(s) therein, from there to and through the second sides of any additional manifold blocks in the series (such as the depicted manifold blocks 7022D 7022E and 7022F), contacting the second sides of the Peltier chip(s) therein and then returning to second tub 7002.

A third loop of fluid, which may be a heat transfer fluid, circulates through tubing through the second manifold of the first manifold block 7022A of the series 7020 of manifold blocks, contacting the first surfaces of the Peltier chip(s) therein, to a corresponding first radiator assembly 7024A, which may include one or more radiators and one or more fans placed to encourage airflow through the radiator(s). One or more fans may be placed to encourage airflow through the first radiator assembly. The fluid then flows from the first radiator assembly 7024A to the first manifold of the subsequent manifold block 7022B, contacting the first surfaces of the Peltier chip(s) therein, and then its corresponding radiator assembly 7024B, which similarly may include one or more radiators and one or more fans placed to encourage airflow through the radiator(s), then returning to the first manifold block 7022A. It will be appreciated that embodiments where the numbers of manifold blocks in the second loop and the third loop may be varied for particular applications. For example, embodiments with only a single manifold block, or three or more manifold blocks and associated radiator assemblies could be present in the third fluid flow loop.

It will be appreciated that selective activation of the third fluid flow loop will allow for operation with excess heat vented from the system 70, so that the system can be operated in a variety of conditions. Including ambient conditions where operation of the first and second loops by themselves would result in the temperature of either tub 7000 or 7002 being outside a desired operating range.

As depicted, suitable pumps 7003, 7007 and 7011 are in operative connection with the respective loops to provide fluid flow and suitable tanks 7001, 7005 and 7009 may be present to provide fluid reservoirs. The pumps may be any pump with sufficient power to circulate the fluids through the tubing at a rate sufficient to allow the system to function at an acceptable rate of heating or cooling. Typically, centrifugal-type pumps may be used, although it may be possible to utilize a larger in-line pump. The bypass valves may be any suitable valves for diverting all or a portion of the fluid flows. The bypass valves may be electronically actuated by the system.

The tubing used to connect the tubs 6000 and 6002 to the temperature control system 702 may be connected to suitable ports in the tubs. Each radiator assembly 7004A, et seq, may include one or more standard radiators consisting of tubing that passes through fins to provide a larger surface area for convection heat exchange to the surrounding air.

It will be appreciated that the different components of the different temperature control systems discussed herein may be utilized with one another for additional flexibility in providing systems with desired features or to allow use in various conditions. For example, the bypass valve arrangements or air pumps for aeration could be utilized in two or three fluid loop systems, with or without radiator assemblies.

It will be further appreciated that the temperature control systems discussed herein could be adapted for use in other applications beyond recreational and therapeutic hot or cold tubs. For example, there could be used for food preparation or food service devices that feature hot and cold portions, or for other therapeutic or medical devices that involve the use of heat therapy and/or cold therapy.

It will be appreciated that the system discussed herein are depicted schematically, rather than to scale and the additional components may be present in systems that incorporate the teachings of the present disclosure to provide additional functionality to such systems. It will be appreciated that the materials used to construct the tubs, tubing, manifolds and other components may be selected to allow for an operation at the desired temperature ranges.

While the disclosure has used the descriptions of certain embodiments to highlight inventive concepts, it will be appreciated such embodiments can be further modified within the spirit and scope of this disclosure. This application is therefore intended to cover any variations, uses, or adaptations of inventions in accordance with the disclosure using its general principles. Further, this application is intended to cover such departures from the present disclosure as come within known or customary practices in the art to which this invention pertains.

What is claimed is:

1. A hot and cold tub system, comprising:
a first tub for holding a first temperate adjusted soaking fluid, the first tub having a first fluid outflow port and a first fluid inflow port;
a second tub for holding a second temperate adjusted soaking fluid, the second tub having a second fluid outflow port and a second fluid inflow port;
at least one manifold block assembly comprising a first manifold and an opposite second manifold attached to one another, wherein
the first manifold in fluid communication with the first fluid outflow port and the first fluid inflow port, the first manifold having at least one recess, and
the second manifold in fluid communication with the second fluid outflow port and the first fluid outflow port, the second manifold having at least one opposite recess;
at least one Peltier element disposed at the at least one recess and the at least one opposite recess, such that the first temperature adjusted soaking fluid directly contacts a first surface of the at least one Peltier element by flowing through the at least one recess in the first manifold and the second temperature adjusted soaking fluid directly contacts a second surface of the at least one Peltier element by flowing through the at least one opposite recess in the second manifold.

2. The system of claim 1, wherein application of current in a first direction to the at least one Peltier element generates heat that is transmitted to the first temperature adjusted fluid to thereby heat the first temperature adjusted fluid in the first tub and a reduction in temperature that is transmitted to the second temperature adjusted fluid to thereby cool the temperature adjust fluid in the second tub.

3. The system of claim 1, wherein the first tub and second tub are contained in a single body.

4. The system of claim 1, wherein the at least one Peltier element comprises a plurality of Peltier elements.

5. The system of claim 4, further comprising a hot side control bypass valve disposed between the first manifold and the first inflow port, the heat control bypass valve actuatable to direct flow from the first manifold from returning to the first tub through the first inflow port to instead return to the first manifold.

6. The system of claim 4, further comprising a cold side control bypass valve disposed between the second manifold and the second inflow port, the cold side control bypass valve actuatable to direct flow from the second manifold from returning to the second tub through the second inflow port to instead return to the second manifold.

7. The system of claim 1, wherein the at least one manifold block comprises a series of manifold blocks.

8. The system of claim 1, further comprising at least one fluid-to-air radiator in fluid communication with the first manifold.

9. A temperature control system, for soaking tub system, comprising:
a first temperature adjustment loop for a first temperate adjusted soaking fluid for a first soaking tub, the loop comprising
at least a first manifold in fluid communication with an outflow from the first soaking tub the at least a first manifold having at one opposite recess;
at least one Peltier element disposed at the at least one recess, such that the first temperature adjusted soaking fluid directly contacts a first surface of the at least one Peltier element by flowing through the at least one recess in the first manifold;
a second temperature adjustment loop for a second temperature adjusted soaking fluid for a second soaking tub, the loop comprising
at least a first opposite manifold in fluid communication with an outflow from the second soaking, the at least a first opposite manifold having at least one opposite recess and the at least one Peltier element disposed in the at least one opposite recess, such that the second temperature adjusted soaking fluid directly contacts a second surface of the at least one Peltier element by flowing through the at least one opposite recess.

10. The system of claim 9, wherein the at least first manifold and the at least first opposite manifold are joined to one another to form a manifold block with the at least one Peltier element retained therebetween.

11. The system of claim 9, wherein application of current in a first direction to the at least one Peltier element generates heat that is transmitted to the first temperature adjusted fluid to thereby heat the first temperature adjusted fluid in the first temperature adjustment loop and a reduction in temperature that is transmitted to the second temperature adjusted fluid to thereby cool the temperature adjust fluid in the second temperature adjustment loop.

12. The system of claim 9, wherein the at least one Peltier element comprises a plurality of Peltier elements.

13. The system of claim 12, further comprising a hot side control bypass valve disposed between the first manifold and a first soaking tub, the heat control bypass valve actuatable to direct flow from the first manifold from returning to the first soaking tub to instead return to the first manifold.

14. The system of claim 12, further comprising a cold side control bypass valve disposed between the second manifold and the second soaking tub, the cold side control bypass valve actuatable to direct flow from the second manifold from returning to the second soaking tub to instead return to the second manifold.

15. The system of claim 9, further comprising at least one fluid-to-air radiator in fluid communication with the first manifold.

16. The system of claim 9, further comprising a mixing bypass valve disposed between the first manifold and the first inflow port, the mixing bypass valve actuatable to direct flow from the first manifold from returning to the first tub through the first inflow port to instead flow to the second inflow port of the second tub.

17. The system of claim 9, wherein the at least one manifold block comprises a series of manifold blocks.

18. The system of claim 17, wherein the system includes third temperature adjustment loop, wherein a first manifold of at least one manifold block of the series of manifold blocks is separated from the first loop of temperature adjusted soaking fluid and flows a separate temperature adjustment fluid which contacts the first surface of the at least one Peltier chip through a radiator assembly then returning to the first manifold.

19. The system of claim 18, wherein the radiator assembly comprises at least one fluid-to air radiator and at least one cooling fan.

20. A temperature controlled tub system, comprising:
a first tub for holding a first temperate adjusted soaking fluid, the first tub having a first fluid outflow port and a first fluid inflow port;
at least one manifold block assembly comprising a first manifold and an opposite second manifold attached to one another, wherein
the first manifold in fluid communication with the first fluid outflow port and the first fluid inflow port, the first manifold having at least one recess, and
at least one Peltier element disposed at the at least one recess and the at least one opposite recess, such that the first temperature adjusted soaking fluid directly contacts a first surface of the at least one Peltier element by flowing through the at least one recess in the first manifold, then returning to the first tub;
at least one radiator assembly in fluid communication opposite second manifold such that a second temperature adjusted fluid directly contacts a second surface of the at least one Peltier element by flowing through the at least one opposite recess in the second manifold in a loop with the at least one radiator assembly.
